(19) United States
(12) Patent Application Publication
(10) Pub. No.: US 2007/0279189 A1
(43) Pub. Date: Dec. 6, 2007

(54) Communication method between host and RFID reader, host device, RFID reader, and RFID communication system

(75) Inventor: Kyung-ho Park, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/633,527

(22) Filed: Dec. 5, 2006

(30) Foreign Application Priority Data
May 16, 2006 (KR) 10-2006-0043814

(51) Int. Cl. H04Q 5/22

(52) U.S. Cl. 340/10.1; 340/572.1; 370/310

(57) ABSTRACT

A communication method between a host and a radio frequency identification (RFID) reader, a host device, an RFID reader, and an RFID communication system using the method are provided. The communication method between a host device and an RFID reader includes transmitting a tag access command to the RFID reader, either of the host device and the RFID reader determining at least one of a tag access end and a tag access completion, and transmitting a tag access result for the tag access command to the host device. Accordingly, the host device and the RFID reader can provide a protocol when the operation of the RFID reader is limited depending on various conditions of the host device.

This application claims priority from Korean Patent Application No. 10-2006-0043814 filed on May 16, 2006, in the Korean Intellectual Property Office, the disclosure of which is incorporated herein by reference.

### BACKGROUND OF THE INVENTION

1. Field of the Invention

Apparatuses and methods consistent with the present invention relate to radio frequency identification (RFID) communication, and more particularly, to an RFID communication between a host and an RFID reader, a host device, an RFID reader, and an RFID communication system using the method.

2. Description of the Related Art

RFID is a technology that incorporates the use of electromagnetic or electrostatic coupling in the radio frequency (RF) portion of the electromagnetic spectrum to uniquely identify an object, animal, or person.

RFID has been developed in compliance with a demand for remedying the defect of the bar code and magnetic card. RFID is a kind of automatic identification data capture (AIDC) technology, whereby data stored in a tag having a built-in microchip is read using the RF signal.

An RFID tag is a device that is attached to a movable good to facilitate the tracking and identifying of the good while the good is moved. That is, the RFID tag is a device that is attached to an object, animal, or person, and makes it possible to automatically identify and track the same through an RFID reader.

The RFID reader can recognize additional data fixed to the identification number of the object related to the RFID tag, and this RFID tag generally includes programmed information on the object.

A related art bar code system requires a manual scanning operation, but the RFID system can automatically identify the object using the above-described information.

As described above, since the RFID system can automatically identify and trace the object, it can be applied to diverse fields such as library, physical distribution such as a large-scaled mart, lending of records, books, and DVDs, and others, and can provide an efficient admin management in comparison to the related art bar code system.

Now, related art RFID systems will be explained.

A host device, for example, a fixed RFID reader terminal (e.g., an RFID reader terminal fixedly installed in a warehouse for taking custody of goods), normally monitors a response of an RFID reader without any particular control. If data is transferred from the RFID reader, the host device collects and transfers the data to a remote DB to store the data in the DB. The RFID reader periodically monitors whether an RFID tag exists around the RFID reader, and if an RFID tag is recognized, transfers the recognized RFID tag to the host device.

An RFID reader included in an information technology (IT) device such as a mobile phone should recognize and transfer an RFID tag within a limited time only when a recognition command is transferred from a host device. Since the operation of the RFID reader may be limited depending on the various conditions of the host device, a protocol to cope with this is required.

In the existing RFID system for distribution, only the RFID tag ID has been recognized. However, in a mobile RFID (MRFID) service, not only the RFID tag ID but also a service code recorded in a memory and application data are necessary, and thus is required to define an access method thereof.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a communication method and a communication system, in which a host device and an RFID reader control RFID communications, respectively, in order to achieve efficient communications.

The present invention also provides host device and an RFID reader which can control RFID communications between the host device and the RFID reader.

According to an aspect of the present invention, there is provided a communication method between a host device and an RFID reader, which include transmitting a tag access command to the RFID reader, either of the host device and the RFID reader determining at least one of a tag access end and a tag access completion, and transmitting a tag access result for the tag access command to the host device.

The tag access end may be determined depending on at least one of the transmission frequency of a fail message, a response time, the number of accessed tags, and whether the host device has performed its original function.

The communication method may further include, in the event that the host device determines whether to end the tag access, transmitting a tag access end command to the RFID reader, and controlling the host device and the RFID reader so that they operate in a standby mode.

The communication method may further include, in the event that the RFID reader determines whether to end the tag access, transmitting a tag access end message to the host device, and controlling the host device and the RFID reader so that they operate in a standby mode.

The tag access completion may be determined depending on at least one of the access frequency, an access time, and the number of accessed tags.

The communication method may further include, in the event that the host device determines whether to complete the tag access, transmitting a tag access completion command to the RFID reader, and controlling the host device and the RFID reader so that they operate in a standby mode.

The communication method may further include, in the event that the RFID reader determines whether to complete the tag access, transmitting a tag access completion command to the host device, and controlling the host device and the RFID reader so that they operate in a standby mode.

The communication method may further include transmitting to the host computer a message reporting whether an operation according to the tag access command has been performed.

The transmitting the tag access result for the tag access command to the host device is performed after either of the tag access end and the tag access completion is performed.

The transmitting the tag access result for the tag access command to the host device transmits the tag access results corresponding to the respective accessed tags to the host device.

The transmitting the tag access result for the tag access command to the host device transmits all the tag access results for all the accessed tags to the host device.

According to another aspect of the present invention, there is provided a communication system which includes an RFID reader accessing a tag, and a host device transmitting a tag access command to the RFID reader and receiving a tag access result for the tag access command, wherein either of the host device and the RFID reader determines at least one of a tag access end and a tag access completion.

The host device may determine at least one of the tag access end and the tag access completion, and transmit a command to the RFID reader corresponding to the result of the determination.

The RFID reader may determine at least one of the tag access end and the tag access completion, and transmit a command to the host device corresponding to the result of the determination.

According to still another aspect of the present invention, there is provided a host device communicating with an RFID reader, which includes an interface unit providing an interface with the RFID reader, and a control unit transferring a tag access command to the RFID reader and receiving a tag access result for the tag access command through the interface unit, wherein the control unit transmits a command that corresponds to at least one of a tag access end and a tag access completion to the RFID reader, and receives a message that corresponds to at least one of the tag access end and the tag access completion from the RFID reader.

According to still another aspect of the present invention, there is provided an RFID reader communicating with a host device, which includes an interface unit providing an interface with the host device, and a control unit receiving a tag access command transmitted from the host device, performing an operation corresponding to the tag access command, and transmitting a tag access result to the host device through the interface unit, wherein the control unit transmits a command that corresponds to at least one of a tag access end and a tag access completion to the host device, and receives a command that corresponds to at least one of the tag access end and the tag access completion from the host device.

According to still another aspect of the present invention, there is provided a communication method for a host device communicating with an RFID reader, which includes transmitting a tag access command to the RFID reader, transmitting a command that corresponds to at least one of a tag access end and a tag access completion to the RFID reader and receiving a message that corresponds to at least one of the tag access end and the tag access completion from the RFID reader, and receiving a tag access result for the tag access command.

In still another aspect of the present invention, there is provided a communication method for a radio frequency identification (RFID) reader communicating with a host device, which includes receiving a tag access command from the host device, transmitting a message that corresponds to at least one of a tag access end and a tag access completion to the host device and receiving a command that corresponds to at least one of the tag access end and the tag access completion from the host device, and performing an operation corresponding to the tag access command and transmitting a tag access result to the host device.

### BRIEF DESCRIPTION OF THE DRAWINGS

The above aspects of the present invention will be more apparent by describing certain exemplary embodiments of the present invention with reference to the accompanying drawings, in which:

FIG. 1 is a block diagram illustrating the construction of a communication system including a host device and an RFID reader according to an exemplary embodiment of the present invention;

FIGS. 2A and 2B are flowcharts explaining the operation of a communication system according to a first communication method according to an exemplary embodiment of the present invention;

FIGS. 3A and 3B are flowcharts explaining the operation of a communication system according to a second communication method according to an exemplary embodiment of the present invention;

FIGS. 4A and 4B and 5A and 5B are flowcharts explaining the operations of a communication system according to a third communication method according to an exemplary embodiment of the present invention; and

FIG. 6 is a block diagram illustrating the construction of the communication system including a host device and an RFID reader according to another exemplary embodiment of the present invention.

### DETAILED DESCRIPTION OF THE EXEMPLARY EMBODIMENTS OF THE INVENTION

Exemplary embodiments of the present invention will be described in detail with reference to the accompanying drawings. In the drawings, the same elements are denoted by the same reference numerals throughout the drawings. In the following description, detailed descriptions of known functions and configurations incorporated herein have been omitted for conciseness and clarity.

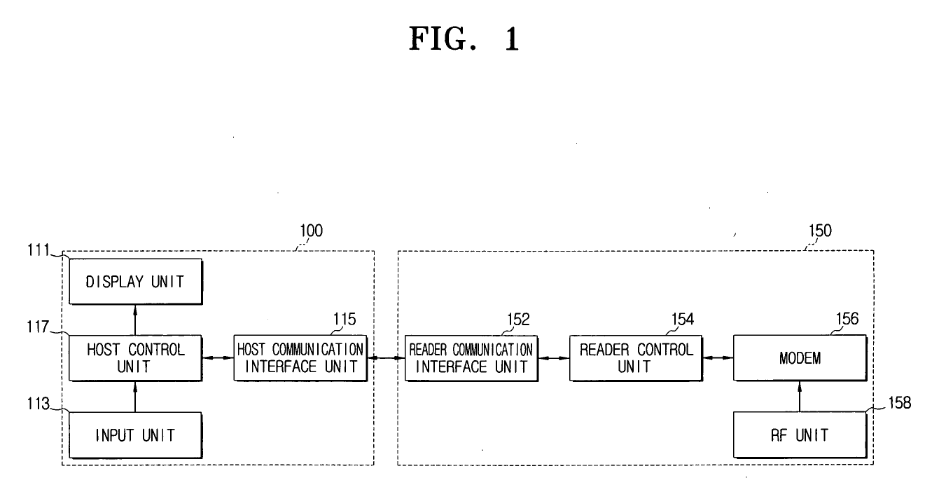

FIG. 1 is a block diagram illustrating the construction of a communication system including a host device and an RFID reader according to an exemplary embodiment of the present invention.

As illustrated in FIG. 1, a host device 100 and an RFID reader 150 may be constructed as a single communication system, or may be constructed as independent devices so that the RFID reader 150 is detachable from the host device 100.

The host device transfers various kinds of commands (e.g., read, write, lock, and kill commands) to the RFID reader 150, so that the RFID reader can access an RFID tag (not illustrated). The RFID reader 150 reads out tag information from an RFID tag, in accordance with various kinds of commands transmitted from the host device 100, transmits the read tag information to the host 100, writes specified information on the RFID tag, kills the tag information recorded on the RFID tag, or locks the RFID tag.

Here, a collective reader access protocol and a progressive reader access protocol may be used as a reader access protocol for the host device's access of the RFID tag through the RFID reader 150. The collective reader access protocol is for the host device 100 to access the RFID tag through the RFID reader 150 using one command, and the progressive reader access protocol is for the host device 100 to access the RFID tag through the RFID reader 150 using two or more commands.

A message transmitted between the host device 100 and the RFID reader 150 is composed of a header, a payload, and a tail. The header is a part that indicates the start of a message, a message type, a command, and the length of a payload. The payload corresponds to data that is actually transferred to host device 100 and the RFID reader 150. The payload transferred from the host device 100 to the RFID reader 150 corresponds to a command-related parameter, and the payload transferred from the RFID reader 150 to the host device 100 corresponds to the result of performing the command of the RFID reader 150. The tail is a part that indicates the end of the message.

The communication method between the host device 100 and the RFID reader may be classified into a host driven type, a reader driven type, and a mixed type communication methods according to whether a leading device is the host device 100 or the RFID reader 150.

In the host driven type communication method, the host device 100 determines a tag access end and a tag access completion. In the reader driven type communication method the RFID reader determines the tag access end and the tag access completion. In the mixed type communication method, the host device 100 may determine the tag access end and the RFID reader 150 may determine the tag access completion. However, in the mixed type communication method, the RFID reader 150 may determine the tag access end and the host device 100 may determine the tag access completion.

Here, if the RFID reader 150 fails to access the RFID tag, the tag access end is determined by the transmission frequency of failure messages transmitted from the RFID reader 150 to the host device 100. That is, if the RFID reader 150 accesses the RFID tag and fails to acquire the tag information, to record specified information, to kill the tag information recorded in the RFID tag, or to lock the RFID tag, it transmits a failure message to the host device 100. If the transmission frequency of the failure message is greater than a predetermined frequency, the host device 100 or the RFID reader 150 determines the tag access end.

In addition, if no response is received from the RFID reader 150 for a predetermined response time after specified command is transmitted from the host device 100 to the RFID reader 150, the tag access end is determined by the host device 100. Also, the tag access end is determined by the host device 100 or the RFID reader 150 if the RFID reader 150 has accessed the predetermined number of RFID tags. Last, the tag access end is determined by the host device 100 or the RFID reader 150 if the host device performs its original function (e.g., when making a phone call and so on).

On the other hand, the tag access completion is determined by the host device 100 or the RFID reader 150 if the RFID reader 150 has accessed the RFID tag for a predetermined time or if the RFID reader 150 has accessed the predetermined number of RFID tags.

Hereinafter, the construction of the host device 100 and the RFID reader 150 will be explained in detail.

First, the host device 100 includes a display unit 111, an input unit, a host communication interface unit 115, and a host control unit 117. Here, the host device 100 may be an IT device such as a mobile phone.

The display unit 111 displays the operation state of the host device 100 and the RFID reader 150, according to the user's manipulation, with text and graphics. The input unit 113 receives an input of a user's manipulation command, and transfers a request signal corresponding to the manipulation command to a host control unit 117 to be explained later.

The host communication interface unit 115 transmits a tag access command, a tag access end command, a tag access completion command, and a response message to the result of tag accesses received from the RFID reader 150 to the RFID reader 150. In addition, the host communication interface unit 115 receives a tag access result transmitted from the RFID reader 150, a tag access end message reporting the tag access end, a tag access completion message reporting the tag access completion, and a tag access start message reporting the tag access start, and transfers the received messages to the host control unit 117.

The host control unit 117 controls the host communication interface unit 115 to transmit the tag access command to the RFID reader 150 and to receive the result of tag access transmitted from the RFID reader 150. The host control unit 117 also controls the operation of the host device 100 and the RFID reader 150 in accordance with the communication method between the host device 100 and the RFID reader 150.

Specifically, in the case of a host driven type communication method, the host control unit 117 determines the tag access end and the tag access completion, controls the host communication interface unit 115 to transmit the tag access end command and the tag access completion command to the RFID reader 150, and controls the host device 100 to operate in a standby mode.

In the case of a reader driven type communication method, the host control unit 117 controls the host device 100 to operate in a standby mode if the tag access end message or the tag access completion message is received from the RFID reader 150.

In the case of a mixed type communication method, the host control unit 117 determines the tag access end, controls the host communication interface unit 115 to transmit the tag access completion command to the RFID reader 150, and controls the host device 100 to operate in a standby mode if the tag access completion message is received from the RFID reader 150. In the same manner, the host control unit 117 determines the tag access completion, controls the host communication interface unit 115 to transmit the tag access end command to the RFID reader 150, and controls the host device 100 to operate in a standby mode if the tag access end message is received from the RFID reader 150.

On the other hand, the RFID reader 150 includes a modem 156, an RF unit 158, a reader communication interface unit 152, and a reader control unit 154.

The reader communication interface unit 152 receives the tag access command, the tag access end command, the tag access completion command, and the response message transmitted through the host communication interface unit 115, and transfers the received commands to the reader control unit 154. In addition, the reader communication interface unit 152 transmits the tag access result, the tag access end message, the tag access completion message, and the tag access start message to the host device 100 under the control of the reader control unit 154.

The reader control unit 154 controls the modem 156 to access the RFID tag in accordance with the tag access command received through the reader communication interface unit 152. In this case, if an access to the RFID tag is possible, the reader control unit 154 controls the reader communication interface unit 152 to transmit the tag access start message to the host device 100, while if the access to the RFID tag is impossible, the reader control unit 154 controls the RFID reader 150 to operate in a standby mode. In addition, the reader control unit 156 controls the reader communication interface unit 152 to transmit the tag information generated by the modem 156 to the host device 100 as the result of tag access.

The modem 156 modulates a digital signal into an analog signal and transfers the modulated signal to the RF unit 158 under the control of the reader control unit 154. Also, the modem 156 generates the tag information by demodulating the analog signal outputted from the RF unit 158 into a digital signal.

The RF unit 158 RF-processes the analog signal outputted from the modem 156, generates and transmits an RF signal to the RFID tag through an antenna (not illustrated). Then, the RF unit 158 recognizes information recorded in the RFID tag through the RF signal, converts the recognized signal into an analog signal of a baseband, and transfers the analog signal to the modem 156.

The reader control unit 154 according to the exemplary embodiment of the present invention controls the operation of the host device 100 and the RFID reader 150 in accordance with the communication method between the host device 100 and the RFID reader 150.

Specifically, in the case of a host driven type communication method, if the tag access end command and the tag access completion command are received from the host device 100, the reader control unit 154 ends and completes the tag access, transmits the tag access end message and the tag access completion message to the host device 100, and then controls the RFID reader 150 to operate in a standby mode.

In the case of a reader driven type communication method, the reader control unit 154 determines the tag access end and the tag access completion, transmits the tag access end message and the tag access completion message to the host device 100, and then controls the RFID reader 150 to operate in a standby mode.

In the case of a mixed type communication method, if the tag access end command is received from the host device 100, the reader control unit 154 ends the tag access, transmits the tag access end message to the host device 100, and then controls the RFID reader 150 to operate in a standby mode. In the same manner, the reader control unit 154 determines the tag access completion, transmits the tag access completion message to the host device 100, and then controls the RFID reader 150 to operate in a standby mode.

On the other hand, if the tag access completion command is received from the host device 100, the reader control unit 154 completes the tag access, transmits the tag access completion message to the host device 100, and then controls the RFID reader 150 to operate in a standby mode. Also, the reader control unit 154, determines the tag access end, transmits the tag access end message to the host device 100, and then controls the RFID reader 150 to operate in a standby mode.

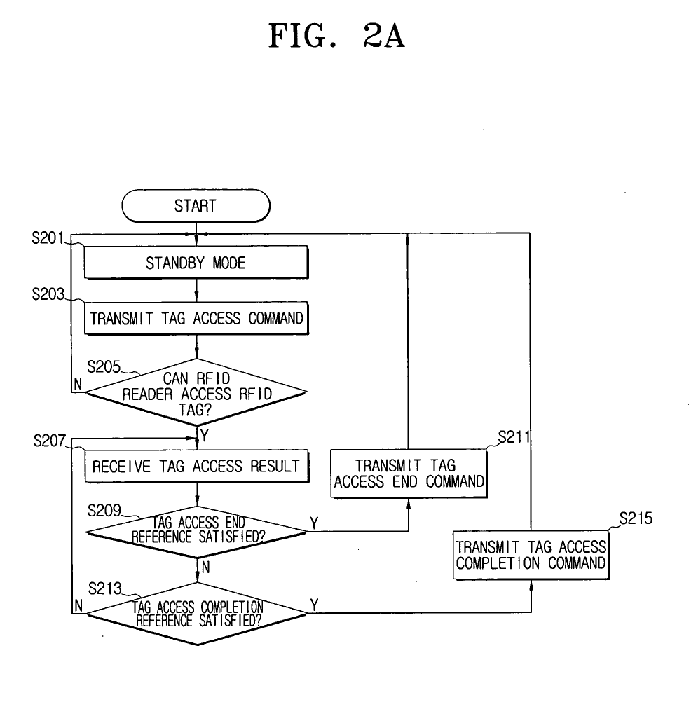

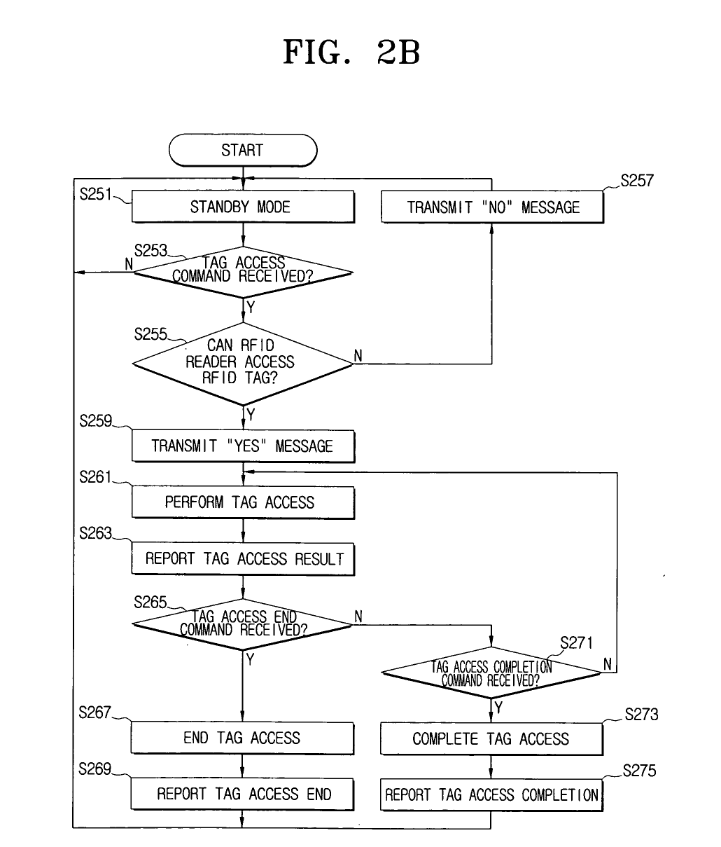

FIGS. 2A and 2B are flowcharts explaining the operation of a communication system according to a first communication method according to an exemplary embodiment of the present invention.

FIG. 2A is a flowchart explaining the operation of a host device 100 included in a communication system adopting the host driven type communication method that is the first communication method.

Referring to FIG. 2A, if the host control unit 117 does not transmit any tag access command to the RFID reader 150, the host device 100 operates in a standby mode (S201). If the host control unit 117 transmits a first tag access command to the RFID reader 150 (S203), the host device 100 leaves the standby mode.

In this case, the host control unit 117 determines whether the RFID reader 150 can access the RFID tag (S205). Here, the host control unit 117 can determine whether the RFID reader can access the RFID tag through the tag access start message transmitted from the RFID reader 150.

If the RFID tag access cannot be performed (S205-N), the host control unit 117 controls the host device 100 to operate in a standby mode (S201). By contrast, if the RFID tag access can be performed (S205-Y), the host control unit 117 receives the tag access result from the RFID reader 150 (S207).

Meanwhile, the host control unit 117, as explained with reference to FIG. 1, determines whether the tag access end reference is satisfied (S209), and if the tag access end is determined (S209-Y), it transmits the tag access end command to the RFID reader 150 (S211). Of course, the host control unit 117 transmits the tag access end command to the RFID reader 150, and then controls the host device 100 to operate in a standby mode (S201).

By contrast, if the tag access end is not determined (S209-N), the host control unit 117 determines whether the tag access completion reference is satisfied (S213). Here, if the tag access completion is not determined (S213-N), the host control unit 117 controls the host communication interface unit to continuously receive the tag access result from the RFID reader 150 (S207).

By contrast, if the tag access completion is determined (S213-Y), the host control unit 117 transmits the tag access completion command to the RFID reader 150 (S215). Of course, the host control unit 117 transmits the tag access completion command to the RFDI reader 150, and then controls the host device 100 to operate in a standby mode (S201).

FIG. 2B is a flowchart explaining the operation of an RFID reader 150 included in a communication system adopting the host driven type communication method that is the first communication method.

Referring to FIG. 2B, the reader control unit 154 controls the RFID reader 150 to operate in a standby mode until the tag access command is received from the host device 100 (S251). If the tag access command is received from the host device 100 (S253-Y), the reader control unit 154 determines whether the tag access can be performed (S255).

If it is determined that the tag access operation is impossible (S255-N), the reader control unit 154 transmits a “NO” message to the host device 100 (S257). By contrast, if it is determined that the tag access operation is possible (S255-Y), the reader control unit 154 transmits a “YES” message to the host device 100 (S259).

After transmitting the “YES” message to the host device 100, the reader control unit 154 controls the RFID reader to access the RFID tag (S261). Here, the reader control unit 154 may not transmit the “YES” message to the host device 100, and control the RFID reader 150 to access the RFID tag.

The reader control unit 154 reports the tag access result obtained by accessing the RFID tag to the host device 100 whenever an RFID tag arbitration process is performed (S263).

On the other hand, if the tag access end command is received from the host device 100 (S265-Y), the reader control unit 154 controls the RFID reader 150 to end the RFID tag access (S267). After the RFID tag access is ended, the reader control unit 154 transmits the tag access end message to the host device 100 to report the result of performing the operation against the tag access end command (S269).

If reader control unit 154 receives the tag access completion command from the host device 100 (S271-Y) in the event that the tag access end command is not received (S265-N), the reader control unit 154 controls the RFID reader 150 to complete the RFID tag access (S273). After completing the RFID tag access, the reader control unit 154 transmits the tag access completion message to the host device 100 to report the result of performing the operation against the tag access completion (S275). By contrast, if the tag access completion command is not received (S271-N), the reader control unit 154 controls the RFID reader 150 to access the RFID tag (S261).

Here, the reader control unit 154 may not transmit the tag access result to the host device 100 just after accessing the RFID tag, but transmit the tag access result to the host device after the tag access end command or the tag access completion command is received. Also, the reader control unit 154 may report the tag access result to the host device 100 without sending a response message to the host device 100 after the reader control unit receives the tag access end command or the tag access completion command.

In transmitting the tag access result, the reader control unit 154 may transmit the tag access results for plural RFID tags one by one, or transmit a message in which the tag access results for the respective RFID tags are included.

Last, according to the exemplary embodiment of the present invention, the host control unit 117 can transfer a message reporting that the tag access result from the RFID reader 150 has been successfully received to the RFID reader 150. If the reader control unit 154 fails to receive the message reporting that the tag access result has been successfully received from the host device 100, or receives a message reporting that the tag access result has not been received, the host control unit may retransmit the corresponding tag access result, or retransmit the corresponding tag access result after the transmission of all the tag access results is completed.

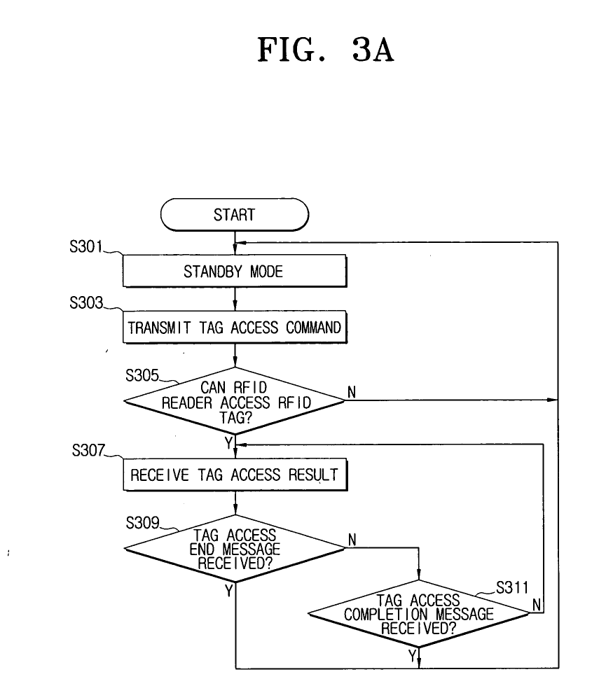

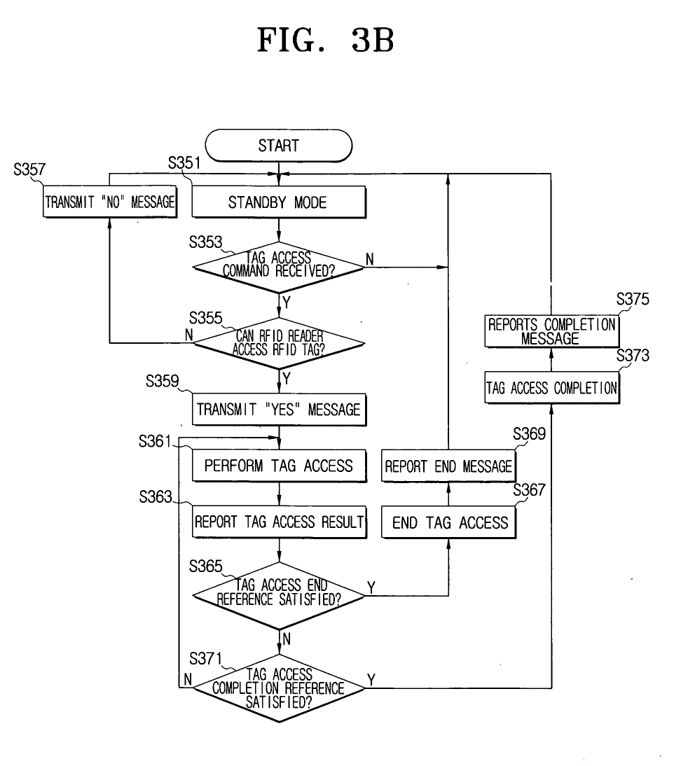

The transmission of the tag access result and the transmission of a message for the tag access result, being performed by the reader control unit 154, can be applied in the same manner to methods as illustrated in FIGS. 3B, 4B, and 5B.

FIGS. 3A and 3B are flowcharts explaining the operation of a communication system according to a second communication method according to an exemplary embodiment of the present invention.

Referring to FIG. 3A, if the host control unit 117 does not transmit any tag access command to the RFID reader 150, the host device 100 operates in a standby mode (S301). If the host control unit 117 transmits a first tag access command to the RFID reader 150 (S303), the host device 100 leaves the standby mode.

In this case, the host control unit 117 determines whether the RFID reader 150 can access the RFID tag (S305). Here, the host control unit 117 can determine whether the RFID reader can access the RFID tag through the tag access start message transmitted from the RFID reader 150.

If the RFID tag access can not be performed (S305-N), the host control unit 117 controls the host device 100 to operate in a standby mode (S301). By contrast, if the RFID tag access can be performed (S305-Y), the host control unit 117 receives the tag access result from the RFID reader 150 (S307).

Here, if the tag access end message is received from the RFID reader 150 (S309-Y), the host control unit 117 controls the host device 100 to operate in a standby mode (S301). Also, if the tag access completion message is received from the RFID reader 150 (S311-Y), the host control unit 117 controls the host device 100 to operate in a standby mode (S301).

FIG. 3B is a flowchart explaining the operation of an RFID reader 150 included in a communication system adopting the reader driven type communication method that is the second communication method.

Referring to FIG. 3B, the reader control unit 154 controls the RFID reader 150 to operate in a standby mode until the tag access command is received from the host device 100 (S351). If the tag access command is received from the host device 100 (S353-Y), the reader control unit 154 determines whether the tag access can be performed (S355).

If it is determined that the tag access operation is impossible (S355-N), the reader control unit 154 transmits a “NO” message to the host device 100 (S357). By contrast, if it is determined that the tag access operation is possible (S355-Y), the reader control unit 154 transmits a “YES” message to the host device 100 (S359).

After transmitting the “YES” message to the host device 100, the reader control unit 154 controls the RFID reader 150 to access the RFID tag (S361). Then, the reader control unit 154 reports the tag access result obtained by accessing the RFID tag to the host device 100 whenever an RFID tag arbitration process is performed (S363).

On the other hand, the reader control unit determines whether the tag access end reference is satisfied, as controlling the RFID reader 150 to access the RFID tag. Here, if it is determines that the tag access end reference is satisfied (S365-Y), the reader control unit 154 controls the RFID reader 150 to end the RFID tag access (S367). After the RFID tag access is ended, the reader control unit 154 reports the tag access end message to the host device (S369).

By contrast, if it is determined that the tag access end reference is not satisfied (S365-N), the reader control unit 154 determines whether the tag access completion reference is satisfied (S371). If it is determined that the tag access completion reference is not satisfied (S371-N), the reader control unit 154 controls the RFID reader to re-perform the RFID tag access (S361).

Meanwhile, if it is determined that the tag access completion reference is satisfied (S371-Y), the reader control unit 154 controls the RFID reader to complete the RFID tag access (S373). After completing the RFID tag access, the reader control unit 154 reports the tag access completion message to the host device 100 (S375).

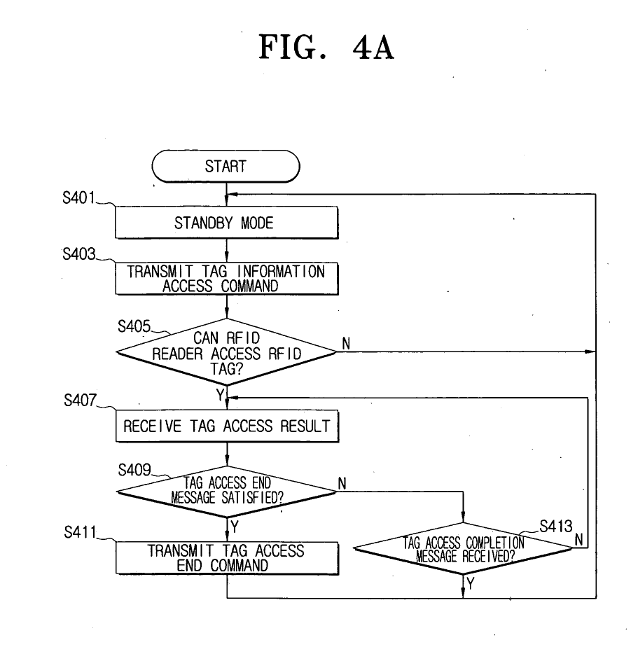

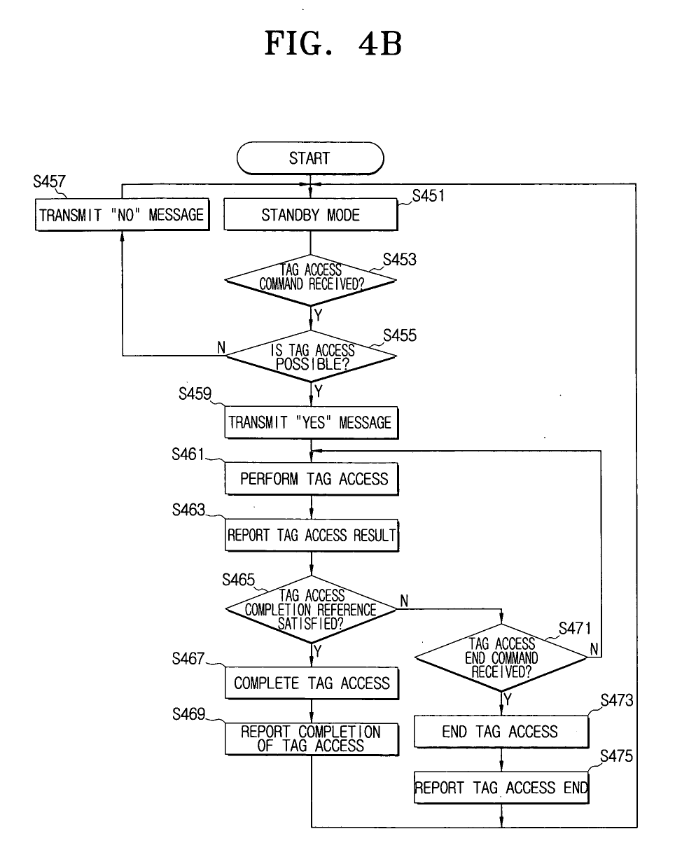

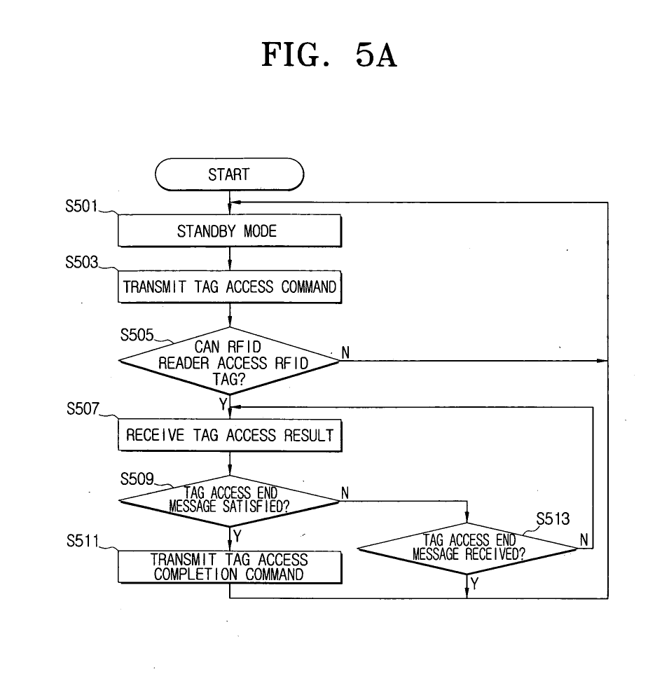

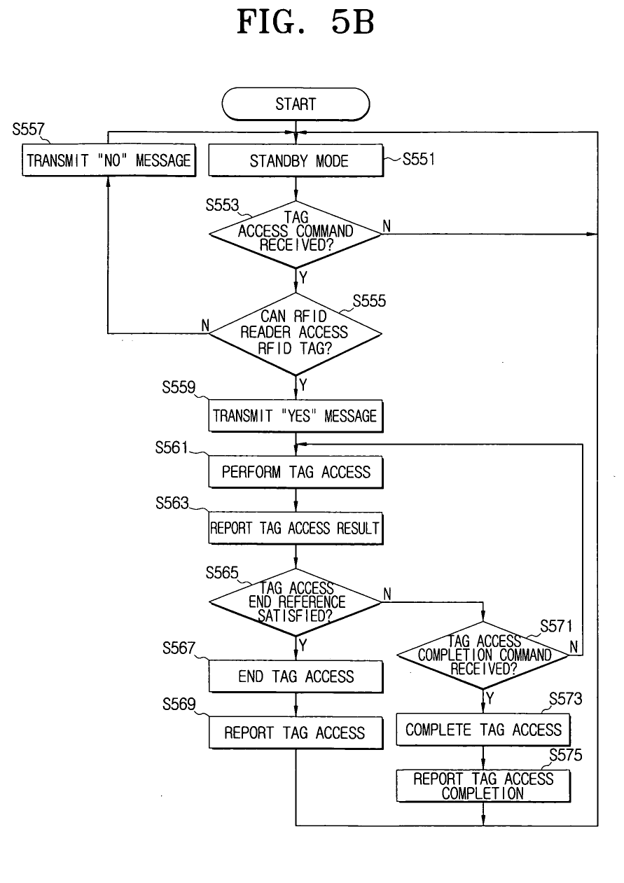

FIGS. 4A and 4B and 5A and 5B are flowcharts explaining the operation of a communication system according to a third communication method according to an exemplary embodiment of the present invention.

FIG. 4A is a flowchart explaining the operation of the host device 100 included in the communication system adopting the mixed type communication method that is the third communication method.

Referring to FIG. 4A, if the host control unit 117 does not transmit any tag access command to the RFID reader 150, the host device 100 operates in a standby mode (S401). If the host control unit 117 transmits a first tag access command to the RFID reader 150 (S403), the host device 100 gets out of the standby mode.

Here, the host control unit 117 determines whether the RFID reader 150 can access the RFID tag (S405). If the RFID tag access can not be performed (S405-N), the host control unit 117 controls the host device 100 to operate in a standby mode (S401). By contrast, if the RFID tag access can be performed (S405-Y), the host control unit 117 receives the tag access result from the RFID reader 150 (S407).

On the other hand, the host control unit 117 determines whether the tag access end reference is satisfied (S409). If it is determined that the tag access end reference is satisfied (S409-Y), the host control unit 117 transmits the tag access end command to the RFID reader 150 (S411). Then, the host control unit 117 controls the host device 100 to operate in a standby mode (S401).

On the other hand, if the tag access completion message is received from the RFID reader 150, the host control unit 117 controls the host device 100 to operate in a standby mode (S401). If the access completion message is not received (S413-N), the host control unit 117 receives the tag access result from the RFID reader 150 (S407).

FIG. 4B is a flowchart explaining the operation of an RFID reader 150 included in a communication system adopting the mixed type communication method that is the third communication method.

Referring to FIG. 4B, the reader control unit 154 controls the RFID reader 150 to operate in a standby mode until the tag access command is received from the host device 100 (S451). If the tag access command is received from the host device 100 (S453-Y), the reader control unit 154 determines whether the tag access can be performed (S455).

If it is determined that the tag access operation is impossible (S455-N), the reader control unit 154 transmits a “NO” message to the host device 100 (S457). By contrast, if it is determined that the tag access operation is possible (S455-Y), the reader control unit 154 transmits a “YES” message to the host device 100 (S459).

After transmitting the “YES” message to the host device 100, the reader control unit 154 controls the RFID reader 150 to access the RFID tag (S461). Then, the reader control unit 154 reports the tag access result obtained by accessing the RFID tag to the host device 100 whenever an RFID tag arbitration process is performed (S463).

On the other hand, the reader control unit 154 determines whether the tag access completion reference is satisfied (S465). If it is determined that the tag access completion reference is satisfied (S465-Y), the reader control unit 154 controls the RFID reader 150 to complete the RFID tag access (S467). After the RFID tag access is completed, the reader control unit 154 reports the RFID tag access completion message to the host device 100 (S469).

On the other hand, if the tag access end command is received from the host device 100 (S471-Y), the reader control unit 154 controls the RFID reader 150 to end the RFID tag access (S473). After the RFID tag access is ended, the reader control unit 154 reports the tag access end to the host device 100 (S475).

FIG. 5A is a flowchart explaining another operation of the host device 100 included in the communication system adopting the mixed type communication method that is the third communication method.

Referring to FIG. 5A, if the host control unit 117 does not transmit any tag access command to the RFID reader 150, the host device 100 operates in a standby mode (S501). If the host control unit 117 transmits a first tag access command to the RFID reader 150 (S503), the host device 100 gets out of the standby mode.

Here, the host control unit 117 determines whether the RFID reader 150 can access the RFID tag (S505). If the RFID tag access can not be performed (S505-N), the host control unit 117 controls the host device 100 to operate in a standby mode (S501). By contrast, if the RFID tag access can be performed (S505-Y), the host control unit 117 receives the tag access result from the RFID reader 150 (S507).

The host control unit 117 determines whether the tag access completion reference is satisfied (S509). If it is determined that the tag access completion reference is satisfied (S509-Y), the host control unit 117 transmits the tag access completion command to the RFID reader 150 (S511). Then, the host control unit 117 controls the host device 100 to operate in a standby mode (S501).

On the other hand, if the tag access end message is received from the RFID reader 150 (S513-Y), the host control unit 117 controls the host device 100 to operate in a standby mode (S501).

FIG. 5B is a flowchart explaining another operation of an RFID reader 150 included in a communication system adopting the mixed type communication method that is the third communication method.

Referring to FIG. 5B, the reader control unit 154 controls the RFID reader 150 to operate in a standby mode until the tag access command is received from the host device 100 (S551). If the tag access command is received from the host device 100 (S553-Y), the reader control unit 154 determines whether the tag access can be performed (S555).

If it is determined that the tag access operation is impossible (S555-N), the reader control unit 154 transmits a “NO” message to the host device 100 (S557). By contrast, if it is determined that the tag access operation is possible (S555-Y), the reader control unit 154 transmits a “YES” message to the host device 100 (S559).

After transmitting the “YES” message to the host device 100, the reader control unit 154 controls the RFID reader 150 to access the RFID tag (S561). Then, the reader control unit 154 reports the tag access result obtained by accessing the RFID tag to the host device 100 whenever an RFID tag arbitration process is performed (S563).

On the other hand, the reader control unit 154 determines whether the tag access end reference is satisfied (S565). If it is judged that the tag access end reference is satisfied (S565-Y), the reader control unit 154 controls the RFID reader 150 to end the RFID tag access (S567). After the RFID tag access is ended, the reader control unit 154 reports the RFID tag access end message to the host device 100 (S569).

On the other hand, if the tag access completion command is received from the host device 100 (S571-Y), the reader control unit 154 controls the RFID reader 150 to complete the RFID tag access (S573). After the RFID tag access is completed, the reader control unit 154 reports the tag access completion message to the host device 100 (S575).

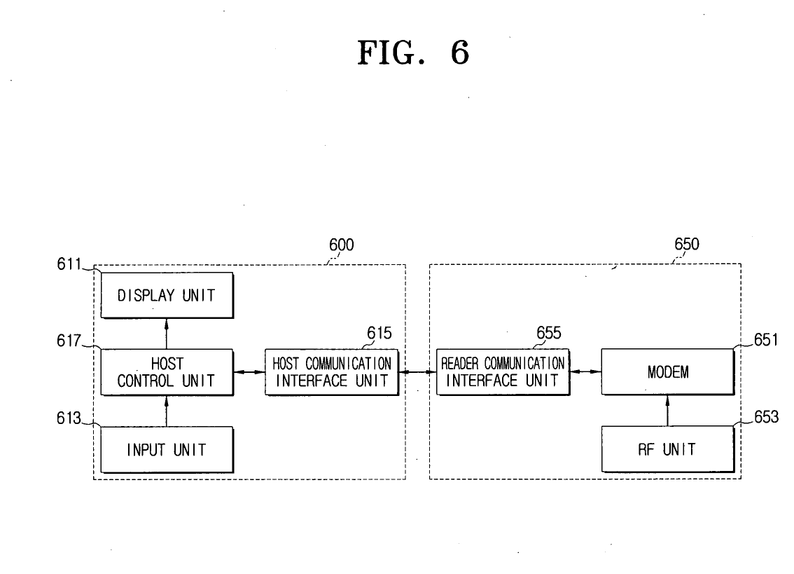

FIG. 6 is a block diagram illustrating the construction of the communication system including a host device and an RFID reader according to another exemplary embodiment of the present invention.

FIG. 6 shows the communication system in which an RFID reader 650 is not provided with a separate control unit according to another exemplary embodiment of the present invention. In this case, a host control unit 617 of a host device 600 directly controls the modem 651 of an RFID reader 650, and the host device 600 recognizes an RFID tag (not illustrated). The first to third communication methods as described above with reference to FIGS. 2A to 5B are applied between the host control unit 617 of the host device 600 and a modem 651 of the RFID reader 650. In FIGS. 1 and 6, it is exemplified that the communication system includes the host device 100 and the RFID reader 150. In addition it will be apparent that the exemplary embodiments of the present invention can be applied to the host device 100 having the RFID reader 150 mounted thereon, and the RFID reader 150 may be detachably mounted on the host computer.

As described above, the communication method controlling the RFID reader, the host device, and the RFID reader according to the exemplary embodiments of the present invention can provide a protocol when the operation of the RFID reader is limited depending on various conditions of the host device.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A communication method between a host device and a radio frequency identification (RFID) reader, the method comprising:
transmitting a tag access command to the RFID reader;
determining at least one of a tag access end and a tag access completion between the host device and the RFID reader; and
transmitting a tag access result for the tag access command to the host device.

2. The communication method of claim 1, wherein the tag access end is determined based on at least one of a transmission frequency of a fail message, a response time, a number of accessed tags, and whether the host device has performed an original function.

3. The communication method of claim 1 further comprising:
transmitting a tag access end command to the RFID reader; and
operating the host device and the RFID reader in a standby mode, if the host device determines to end tag access.

4. The communication method of claim 1, further comprising:
transmitting a tag access end message to the host device; and
operating the host device and the RFID reader in a standby mode, if the RFID reader determines to end tag access.

5. The communication method of claim 1, wherein the tag access completion is determined based on at least one of access frequency, an access time, and a number of accessed tags.

6. The communication method of claim 1 further comprising:
transmitting a tag access completion command to the RFID reader; and
operating the host device and the RFID reader in a standby mode, if the host device determines to complete tag access.

7. The communication method of claim 1 further comprising:
transmitting a tag access completion command to the host device; and
operating the host device and the RFID reader in a standby mode, if the RFID reader determines to complete tag access.

8. The communication method of claim 1, further comprising:
transmitting a message reporting to the host computer indicating whether an operation according to the tag access command has been performed.

9. The communication method of claim 1, wherein the transmitting the tag access result for the tag access command to the host device is performed after performing the tag access end or the tag access completion.

10. The communication method of claim 1, wherein transmitting the tag access result for the tag access command to the host device transmits tag access results corresponding to respective accessed tags to the host device.

11. The communication method of claim 1, wherein the operation of transmitting the tag access result for the tag access command to the host device transmits all the tag access results for all the accessed tags to the host device.

12. A communication system comprising:
a radio frequency identification (RFID) reader which accesses a tag; and
a host device which transmits a tag access command to the RFID reader and receives a tag access result for the tag access command,
wherein one of the host device and the RFID reader determines at least one of a tag access end and a tag access completion.

13. The communication system of claim 12, wherein the host device determines at least one of the tag access end and the tag access completion, and transmits a command to the RFID reader corresponding to a result of the determination.

14. The communication system of claim 12, wherein the RFID reader determines at least one of the tag access end and the tag access completion, and transmits a command to the host device corresponding to a result of the determination.

15. A host device communicating with a radio frequency identification (RFID) reader, the host device comprising:
an interface unit which provides an interface with the RFID reader; and
a control unit which transfers a tag access command to the RFID reader and receiving a tag access result for the tag access command through the interface unit,
wherein the control unit transmits to the RFID reader a command corresponding to at least one of a tag access end and a tag access completion, and receives from the RFID reader a message that corresponds to at least one of the tag access end and the tag access completion.

16. A radio frequency identification (RFID) reader communicating with a host device, the host device comprising:
an interface unit which provides an interface with the host device; and
a control unit which receives a tag access command transmitted from the host device, performing an operation corresponding to the tag access command, and transmitting a tag access result to the host device through the interface unit,
wherein the control unit transmits to the host device a first command corresponding to at least one of a tag access end and a tag access completion, and receives from the host device a second command corresponding to at least one of the tag access end and the tag access completion.

17. A communication method for a host device communicating with a radio frequency identification (RFID) reader, the method comprising:
transmitting a tag access command to the RFID reader;
transmitting to the RFID reader a command corresponding to at least one of a tag access end and a tag access completion;
receiving from the RFID reader a message that corresponds to at least one of the tag access end and the tag access completion; and
receiving a tag access result for the tag access command.

18. A communication method for a radio frequency identification (RFID) reader communicating with a host device, the method comprising:
receiving a tag access command from the host device;
transmitting to the host device a message corresponding to at least one of a tag access end and a tag access completion;
receiving from the host device a command corresponding to at least one of the tag access end and the tag access completion;
performing an operation corresponding to the tag access command; and
transmitting a tag access result to the host device.
